(19) United States
(12) Patent Application Publication
(10) Pub. No.: US 2008/0106147 A1
(43) Pub. Date: May 8, 2008

(54) APPARATUS AND SYSTEM FOR MEASUREMENT AND CONTROL OF ELECTRICAL POWER CONSUMPTION

(75) Inventors: Robert J. Caggiano, Wolcott, CT (US); John Dubeck, West Hartford, CT (US); Uzoma K. Nsofor, New Haven, CT (US); Cecil Rivers, Hartford, CT (US); Sohaib U. Shaikh, East Windsor, CT (US); Jaime Villamarin, Elmhurst, NY (US)

Correspondence Address: CANTOR COLBURN, LLP, 20 Church Street, 22nd Floor, Hartford, CT, 06103, US

(73) Assignee: GENERAL ELECTRIC COMPANY, Schenectady, NY (US)

(21) Appl. No.: 11/557,679

(22) Filed: Nov. 8, 2006

(51) Int. Cl. H02J 3/00

(52) U.S. Cl. 307/39; 307/126

(57) ABSTRACT

A measurement and control apparatus is disclosed having power input terminals configured to connect with a power source, power output terminals configured to connect with a load, the output terminals being switchably connected to the input terminals, and an actuator configured to switchably connect and disconnect the output terminals to the input terminals upon command. The control apparatus also includes circuitry configured to measure the voltage applied to and the current supplied to the load, circuitry configured to transmit data representative of the applied voltage and the supplied current to a control unit, and circuitry configured to receive a command from the control unit, and in response thereto to switchably connect and disconnect the output terminals from the input terminals.

### BACKGROUND OF THE INVENTION

The present disclosure relates generally to an apparatus and system for the measurement and control of electrical power consumption.

Power monitoring devices presently employed in or in connection with panelboards of electrical distribution systems typically provide information concerning the power consumption in an entire branch circuit. During reduced power conditions, other power monitoring devices control load connectivity based on information about whether the electrical source can support additional loads. Other power monitoring devices that connect with a specific load merely provide power consumption information.

Accordingly, there remains a need in the art for a monitoring and control apparatus and system that provides for a greater degree of monitoring and control of individual loads than is presently available.

### BRIEF DESCRIPTION OF THE INVENTION

An embodiment of the invention includes a measurement and control apparatus having power input terminals configured to connect with a power source, power output terminals configured to connect with a load, the output terminals being switchably connected to the input terminals, and an actuator configured to switchably connect and disconnect the output terminals to the input terminals upon command. The control apparatus also includes circuitry configured to measure the voltage applied to and the current supplied to the load, circuitry configured to transmit data representative of the applied voltage and the supplied current to a control unit, and circuitry configured to receive a command from the control unit, and in response thereto to switchably connect and disconnect the output terminals from the input terminals.

Another embodiment of the invention includes a system for controlling multiple electrical loads. The system includes a control unit, and a plurality of measurement and control apparatus. Each apparatus having power input terminals configured to connect with a power source, power output terminals configured to connect with a load, the output terminals being switchably connected to the input terminals, and an actuator configured to switchably connect and disconnect the output terminals to the input terminals upon command. Each apparatus also includes circuitry configured to measure the voltage applied to and the current supplied to the load, circuitry configured to transmit data representative of the applied voltage and the supplied current to the control unit, and circuitry configured to receive a command from the control unit, and in response thereto to switchably connect and disconnect the output terminals from the input terminals. The control unit is in signal communication with the plurality of apparatus, is configured to monitor the power consumption provided by each of the apparatus, and is configured to provide a control signal to each of the apparatus to switchably disconnect a particular apparatus in response to a threshold power usage from that apparatus exceeding a threshold.

### BRIEF DESCRIPTION OF THE DRAWINGS

Referring to the exemplary drawings wherein like elements are numbered alike in the accompanying Figures:

FIG. 1 depicts an exemplary system for monitoring and controlling power to a load in accordance with an embodiment of the invention;

FIGS. 2-4 depict alternative monitor and control apparatus for use in the system of FIG. 1 in accordance with an embodiment of the invention; and

FIG. 5 depicts an alternative system to that depicted in FIG. 1.

### DETAILED DESCRIPTION OF THE INVENTION

An embodiment of the invention, as shown and described by the various figures and accompanying text, provides an apparatus and system to monitor and control electrical power consumption at one or a plurality of electrical appliances, and to cause the one or selected appliances of the plurality to turn on and off on command, thereby providing level loading of distributed circuits, and load shedding in response to a threshold power consumption being exceeded in a peak billing time period.

Embodiments of the invention may be composed of two components, which are characterized generally as a sensing module and a user interface. The sensing module measures the power consumed by a connected appliance load and transmits this data to the user interface via a communication path, which may be but is not necessarily a wireless communication arrangement. The sensing module also contains a switching mechanism controlled by the user interface. The user interface displays the power consumption data to a user along with the state of the sensing module switch (on/off). Along with being able to monitor the appliance load power consumption, the user will also be able to set the on/off state of the appliance via the user interface. The user interface also allows the user to program the on/off state of the appliance and set a power consumption threshold for power being consumed by the appliance. In an embodiment, multiple sensing modules can be connected to a single user interface. An example of a user interface is a personal computer with package software installed. An exemplary sensing module is of a duplex outlet plug-in type, providing an intermediate connection between an existing duplex power outlet and the appliance load.

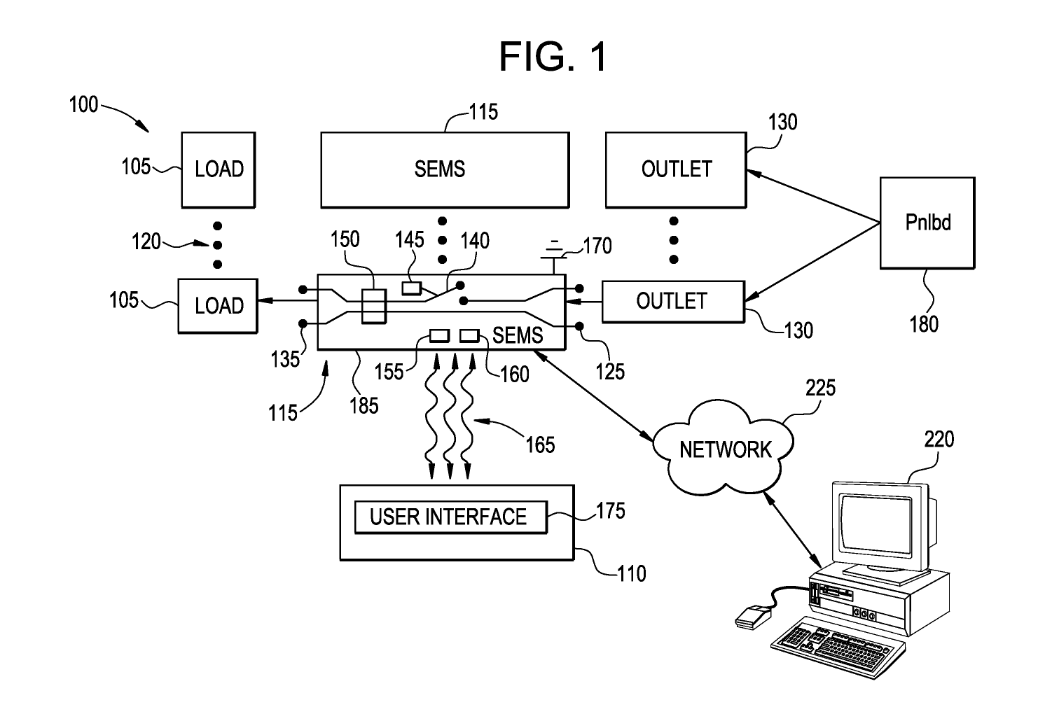

FIG. 1 is an exemplary embodiment of a system 100 for controlling multiple electrical appliances or loads 105. In an embodiment, the system 100 includes a control unit 110, and a plurality of measurement and control apparatus 115 that are configured to be in signal communication with the control unit 110 via signal path 165. While FIG. 1 depicts only a single apparatus 115 and multiple loads 105, it will be appreciated that ellipses 120 represent a plurality of repetitive devices, with each of the plurality of apparatus 115 corresponding with and servicing a particular load 105. Each apparatus 115, also herein referred to as a smart electronic measurement system (SEMS), includes power input terminals 125 configured to connect with a power source 130, such as a duplex outlet for example, and power output terminals 135 configured to connect with a load 105. In an embodiment, power input terminals 125 are configured as prongs that plug into a duplex outlet, and power output terminals 135 are configured the same as a duplex outlet with ground 170. Between the input and output terminals is a switch 140 disposed and configured to switchably connect and disconnect the output terminals to the input terminals via an actuator 145 that operates upon command via a signal 165 from the control unit 110. SEMS 115 also includes circuitry 150 configured to measure the voltage applied to and the current supplied to the load 105, circuitry 155 configured to transmit data representative of the applied voltage and the supplied current to the control unit 110 via signal path 165, and circuitry 160 configured to receive a command from the control unit 110 via signal path 165. In response to a signal 165 from the control unit 110, SEMS 115 switchably connects or disconnects the output terminals from the input terminals. In an embodiment, measurement circuitry 150 includes a MEMS (micro-electromechanical system) current sensor, such as described in commonly assigned U.S. Patent Publication No. 2005/0270014, which is incorporated herein by reference in its entirety. However, the scope of the invention is not limited to the measurement circuitry 150 being a MEMS current sensor, but also encompasses other current sensing devices such as a Hall Effect current sensor, a shunt resistor current sensor, a Current Transformer current sensor, or any other current sensing device suitable for the purposes disclosed herein. In an embodiment, control unit 110 is configured to be in signal communication with the plurality of apparatus 115 via signal path 165, is configured to monitor the power consumption provided by each of the apparatus 115 to their respective loads 105, is configured to provide a control signal 165 to each of the apparatus 115 to switchably connect a particular apparatus 115 to a corresponding load 105 upon command, and is configured to provide a control signal 165 to each of the apparatus 115 to switchably disconnect a particular apparatus 115 in response to a threshold power usage from that apparatus 115 to the associated load 105 exceeding a threshold.

In an embodiment, it is the control unit 110 that determines, via signals from apparatus 115, whether the power being supplied to the respective load 105 is in excess of a threshold, and in response thereto the actuator 145 is responsive to a signal received at the receive circuitry 160 from the control unit 110 to switchably disconnect the power output terminals 135 from the power input terminals 125.

In an embodiment, control unit 110 is configured to provide a control signal 165 to each of the apparatus 115 to switchably connect or disconnect a particular apparatus 115 to/from an associated load 105 in response to a defined time of day, which in one embodiment corresponds to a peak billing time, and in another embodiment corresponds to a programmable time.

In an embodiment, and to enable proper communication between controller 110 and each apparatus 115, each of the plurality of apparatus 15 are provided with a unique communication address thereby allowing the control unit 110 to communicate with each of the apparatus separately of another apparatus.

In an embodiment, control unit 110 comprises a user interface 175 configured to allow a user to manually cause a particular apparatus to switchably change from a connected state to a disconnected state, and vice versa. User interface 175 may be a set of control buttons, a touch sensitive screen, or any other interface useful for the purposes disclosed herein. In an alternative embodiment, control unit 110 and user interface 175 are part of a computer 220, such as a personal computer (desktop, laptop, or notebook for example) but not limited to any particular software platform (Microsoft™ based, or Apple™ based for example). In an embodiment, computer 220 is in signal communication with control apparatus 115 via a direct link or via a network 225, the communication links being wired or wireless. In an embodiment, the user interface 175 is configured (via hardware, software or the combination thereof) to allow a user to manually cause an apparatus 115 of the plurality of measurement and control apparatus to transmit a signal representative of a voltage and a current applied to the load 105.

In an embodiment, signal path 165 is the same wire that carries the voltage from a panelboard 180 servicing the outlet 130 that apparatus 115 is connected to, thereby enabling the transmit circuitry 155 and the receive circuitry 160 to transmit and receive data to and from an external control unit 110 via the power line at a communication frequency that is higher than the frequency at which the power is distributed. This type of communication is referred to in the art as powerline carrier communication. In another embodiment, signal path 165 is a radio frequency (RF) signal path, thereby enabling the transmit circuitry 155 and the receive circuitry 160 to transmit and receive data to and from an external control unit 110 via wireless communication. In yet another embodiment, signal path 165 is a configured as structured control wiring, such as RS-485 cable for example, thereby enabling the transmit circuitry 155 and the receive circuitry 160 to transmit and receive data to and from an external control unit 110 via a dedicated communication scheme.

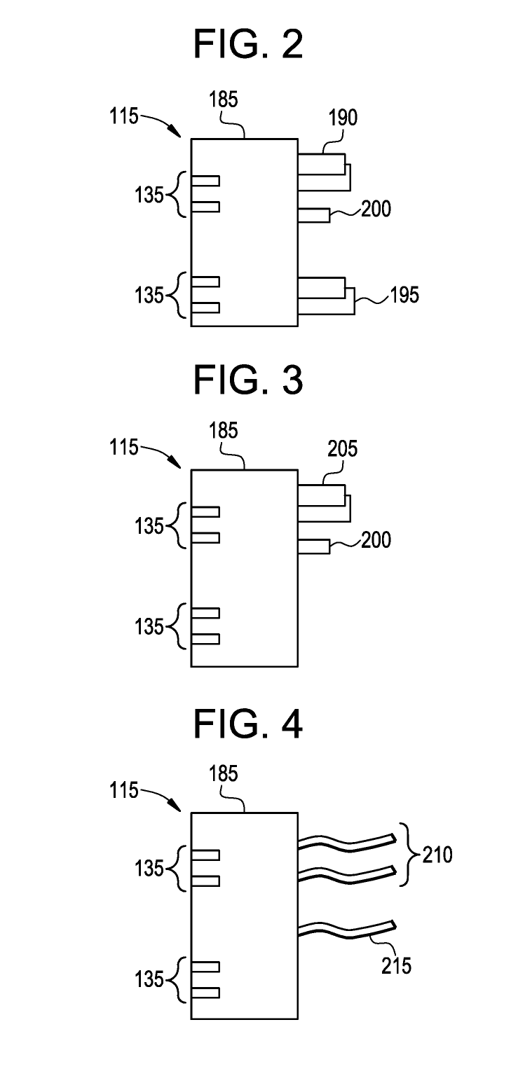

Referring now to FIGS. 2-4, alternative arrangements for a SEMS unit 115 will be described.

In FIG. 2, SEMS unit 115 is configured having a housing 185 with two sets of prongs 190, 195 that are disposed on the back of the SEMS unit 115 and configured to plug into the two outlets of a duplex wall outlet. The two sets of prongs 190, 195 serve as the power input terminals 125. In an embodiment, prongs 190, 195 are polarized to provide proper polarity connection to the hot and neutral conductors from the panelboard 180. A ground plug 200 is also provided, which is synonymous with the ground connection 175 depicted in FIG. 1. On the front of SEMS unit 115 is the power output terminals 135 that are configured in a manner similar to a duplex wall outlet with ground, which in an embodiment are also polarized. Between input terminals and output terminals, the switch 140, actuator 145, measurement circuitry 150, transmit circuitry 155, and receive circuitry 160 are disposed and configured as described above with reference to FIG. 1. In the embodiment of FIG. 2, SEMS unit 115 is configured to plug into both outlets of a duplex wall outlet, and to provide power measurement and control of any downstream connected load that would ordinarily have been plugged into the duplex wall outlet that the SEMS unit 115 is plugged into.

In FIG. 3, SEMS unit 115 is configured having a housing 185 with one set of prongs 205 that are disposed on the back of the SEMS unit 115 and configured to plug into one of the two outlets of a duplex wall outlet. The set of prongs 205 serve as the power input terminals 125. In an embodiment, prongs 205 are polarized to provide proper polarity connection to the hot and neutral conductors from the panelboard 180. A ground plug 200 is also provided, which is synonymous with the ground connection 175 depicted in FIG. 1. On the front of SEMS unit 115 is the power output terminals 135 that are configured in a manner similar to a duplex wall outlet with ground, which in an embodiment are also polarized. Between input terminals and output terminals, the switch 140, actuator 145, measurement circuitry 150, transmit circuitry 155, and receive circuitry 160 are disposed and configured as described above with reference to FIG. 1. In the embodiment of FIG. 3, SEMS unit 115 is configured to plug into one of the two outlets of a duplex wall outlet, and to provide power measurement and control of any downstream connected load that would ordinarily have been plugged into the one outlet of the original duplex wall outlet that the SEMS unit 115 is plugged into. The other outlet of the original duplex wall outlet is left available for other use that is not monitored and controlled by the SEMS unit 115.

In FIG. 4, SEMS unit 115 is configured having a housing 185 with power leads 210 disposed on the back of the SEMS unit 115 and configured to be hardwired to a power circuit being fed by the panelboard 180 (see FIG. 1). The power leads 210 serve as the power input terminals 125. A ground wire 215 is also provided, which is synonymous with the ground connection 175 depicted in FIG. 1. On the front of SEMS unit 115 is the power output terminals 135 that are configured in a manner similar to a duplex wall outlet with ground, which in an embodiment are also polarized. Between input terminals and output terminals, the switch 140, actuator 145, measurement circuitry 150, transmit circuitry 155, and receive circuitry 160 are disposed and configured as described above with reference to FIG. 1. In the embodiment of FIG. 4, SEMS unit 115 is configured to be installed into a wall-mounted electrical box in a manner similar to how a standard duplex wall outlet is installed, and to provide power measurement and control for any downstream connected load. In an embodiment, the SEMS unit 115 of FIG. 4 is configured to replace an existing duplex wall outlet, thereby enabling old-work retrofit of the SEMS measurement and control apparatus.

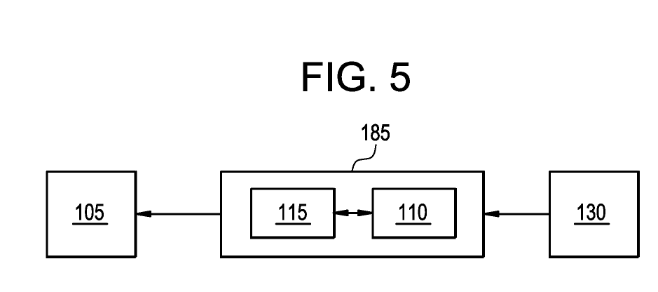

While an embodiment of the invention has been described employing a control unit 110 that is external to apparatus 115, it will be appreciated that the scope of the invention is not so limited, and that the scope of the invention also encompasses a control unit 110 that is disposed internal to the housing 185 of apparatus 115, thereby enabling localized measurement and control of loads 105 connected to and serviced by power source 130 via apparatus 115. Such a configuration is depicted in FIG. 5. From the foregoing, it will be appreciated that the various installation configurations described above with reference to FIGS. 2-4 may also apply to the embodiment depicted in FIG. 5.

An embodiment of the invention may be embodied in the form of computer-implemented processes and apparatuses for practicing those processes. The present invention may also be embodied in the form of a computer program product having computer program code containing instructions embodied in tangible media, such as floppy diskettes, CD-ROMs, hard drives, USB (universal serial bus) drives, or any other computer readable storage medium, such as read-only memory (ROM), random access memory (RAM), and erasable-programmable read only memory (EPROM), for example, wherein, when the computer program code is loaded into and executed by a computer or other processing circuit, the computer or processor becomes an apparatus for practicing the invention. The present invention may also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing the invention. When implemented on a general-purpose microprocessor, the computer program code segments configure the microprocessor to create specific logic circuits. A technical effect of the executable instructions is to monitor and control electrical power consumption at a plurality of electrical appliances, and to cause selected appliances to turn on and off on command.

As disclosed, some embodiments of the invention may include some of the following advantages: an apparatus as disclosed herein that is capable of monitoring and controlling power usage without requiring a skilled technician for the installation thereof; an apparatus as disclosed herein that provides multiple load monitoring and controlling via a central control unit; an apparatus as disclosed herein having a single user display for monitoring and controlling a plurality of loads; a monitoring and control apparatus as disclosed herein that is configured for remote control wireless operation; and, the ability for a user (customer) to operate multiple and varied electrical appliances while maintaining a maximum total power consumption level.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A measurement and control apparatus, comprising:
power input terminals configured to connect with a power source;
power output terminals configured to connect with a load, the output terminals being switchably comnected to the input terminals;
an actuator configured to switchably connect and disconnect the output terminals to the input terminals upon command;
circuitry configured to measure the voltage applied to and the current supplied to the load;
circuitry configured to transmit data representative of the applied voltage and the supplied current to a control unit; and
circuitry configured to receive a command from the control unit, and in response thereto to switchably connect and disconnect the output terminals from the input terminals.

2. The apparatus of claim 1, wherein the power input terminals are configured to plug into one of two outlets of a duplex outlet.

3. The apparatus of claim 1, wherein the power input terminals are configured to plug into both outlets of a duplex outlet.

4. The apparatus of claim 1, wherein the power output terminals are configured as a polarized duplex outlet with ground connection.

5. The apparatus of claim 1, wherein:
the power input terminals are configured to be hardwired to the power source; and
the power output terminals are configured as a polarized duplex outlet with ground connection.

6. The apparatus of claim 1, wherein the control unit is external to the apparatus, and further wherein:
the transmit circuitry and the receive circuitry are configured to transmit and receive data to and from the external control unit over a power line connected with the power source at a frequency higher than the frequency at which the power is distributed.

7. The apparatus of claim 1, wherein the control unit is external to the apparatus, and further wherein:
the transmit circuitry and the receive circuitry are configured to transmit and receive data to and from the external control unit via wireless communication.

8. The apparatus of claim 1, wherein:
in response to the control unit determining that the power being supplied to the load is in excess of a threshold, the actuator is responsive to a signal received at the receive circuitry from the control unit to switchably disconnect the power output terminals from the power input terminals.

9. The apparatus of claim 1, further comprising the control unit that is internal of a housing of the apparatus.

10. The apparatus of claim 1, wherein the measurement circuitry comprises a MEMS current sensor, a Hall Effect current sensor, a shunt resistor current sensor, or a Current Transformer current sensor.

11. A system for controlling multiple electrical loads, the system comprising:
a control unit; and
a plurality of measurement and control apparatus, each apparatus comprising:
power input terminals configured to connect with a power source;
power output terminals configured to connect with a load, the output terminals being switchably comnected to the input terminals;
an actuator configured to switchably connect and disconnect the output terminals to the input terminals upon command;
circuitry configured to measure the voltage applied to and the current supplied to the load;
circuitry configured to transmit data representative of the applied voltage and the supplied current to the control unit; and
circuitry configured to receive a command from the control unit, and in response thereto to switchably connect and disconnect the output terminals from the input terminals;
wherein the control unit is in signal communication with the plurality of apparatus, is configured to monitor the power consumption provided by each of the apparatus, and is configured to provide a control signal to each of the apparatus to switchably disconnect a particular apparatus in response to a threshold power usage from that apparatus exceeding a threshold.

12. The system of claim 11, wherein the control unit is configured to provide a control signal to each of the apparatus to switchably connect or disconnect a particular apparatus in response to a defined time of day.

13. The system of claim 11, wherein each of the plurality of apparatus have a unique communication address thereby allowing the control unit to communicate with each of the apparatus separately.

14. The system of claim 11, wherein the control unit comprises a user interface configured to allow a user to manually cause a particular apparatus to switchably change from a connected state to a disconnected state, and vice versa.

15. The system of claim 14, wherein the user interface comprises a touch sensitive screen.

16. The system of claim 14, wherein the user interface is configured to allow a user to manually cause an apparatus of the plurality of measurement and control apparatus to transmit a signal representative of a voltage and a current applied to the load.

17. The system of claim 14, wherein the user interface comprises a computer in signal communication with a network.
